(19) United States
(12) Patent Application Publication
(10) Pub. No.: US 2012/0030652 A1
(43) Pub. Date: Feb. 2, 2012

(54) Mechanism for Describing Values of Optimized Away Parameters in a Compiler-Generated Debug Output

(76) Inventor: Jakub Jelinek, Roztoky (CZ)

(21) Appl. No.: 12/847,458

(22) Filed: Jul. 30, 2010

(51) Int. Cl. G06F 9/45; G06F 9/44

(52) U.S. Cl. 717/124; 717/140

(57) ABSTRACT

A mechanism for describing values of optimized away parameters in a compiler-generated debug output. A method of embodiments of the invention includes monitoring parameters in a source code during compilation of the source code by a compiler on a computer system. Each parameter includes a value and is optimized away during optimization of the source code into an optimized code. The method further includes generating status information that relates to the parameters based on the monitoring of the parameters, and providing the status information in a debug output that is generated by the compiler. The status information is used to recover values of the parameters missing from the optimized code.

### TECHNICAL FIELD

The embodiments of the invention relate generally to compiler optimization and, more specifically, relate to a mechanism for describing values of optimized away parameters in a compiler-generated debug output.

### BACKGROUND

In software programming, it is well-known that when a source code is optimized to work more efficiently, certain source code-level parameters are lost during source code or program optimization (“code optimization”) and do not reach the final compiler-generated debug output. Since a source code is optimized to work more efficiently (such as in terms of storage, power, time, etc.), processor registers that typically store values of parameters are often called to be reused for other purposes (such as when a function having a parameter calls another function) and consequently, the parameter values are “optimized away” and do not survive long enough to be used for debugging. The debugger is unable to disclose parameter values and merely informs the user (e.g., software developer, programmer) that the parameters have been optimized away. Thus, any user seeking a parameter value has to perform an inefficient, time-consuming and cumbersome task of manual debugging to locate the parameter value with a fair chance of being unsuccessful at it.

### BRIEF DESCRIPTION OF THE DRAWINGS

The invention will be understood more fully from the detailed description given below and from the accompanying drawings of various embodiments of the invention. The drawings, however, should not be taken to limit the invention to the specific embodiments, but are for explanation and understanding only.

FIG. 1 illustrates a host machine 100 and a remote machine 120 employing a system for describing optimized away parameters according to one embodiment of the invention;

FIG. 2 illustrates a method for describing optimized away parameters according to one embodiment of the invention;

FIG. 3 illustrate a system 300 for describing optimized away parameters and locating their values according to one embodiment of the invention;

FIG. 4 illustrates a method for describing values of optimized away parameters according to one embodiment of the invention;

FIG. 5 illustrates a method for describing values of optimized away parameters according to one embodiment of the invention; and

FIG. 6 illustrates one embodiment of a computer system.

### DETAILED DESCRIPTION

Embodiments of the invention provide for describing values of optimized away parameters in a compiler-generated debug output. A method of embodiments of the invention includes monitoring parameters in a source code during compilation of the source code by a compiler on a computer system. Each parameter includes a value and is optimized away during optimization of the source code into an optimized code. The method further includes generating status information that relates to the parameters based on the monitoring of the parameters, and providing the status information in a debug output that is generated by the compiler. The status information is used to recover values of the parameters missing from the optimized code.

The embodiments of the invention are used to improve software compilation and optimized code debugging by providing a technique for describing values of optimized away parameters in compiler-generated debut output (“debug output”) and locating those values using the debug output. In one embodiment, source code parameters are monitored during compilation and certain relevant verification information (also referred to as “description information” or “status information”) is generated and provided in the debug output. The debugger accesses the debug output and is provided the ability to access and use the verification information in the debug output to locate values of the optimized away parameters and any related variables. Once the values are located, they are then provided to the user. By having a compiler and debugger describe and locate values of optimized away parameters and their corresponding variables, the debugging of optimized codes is significantly improved by greatly reducing the human factor from the process and without compromising the optimized code efficiency.

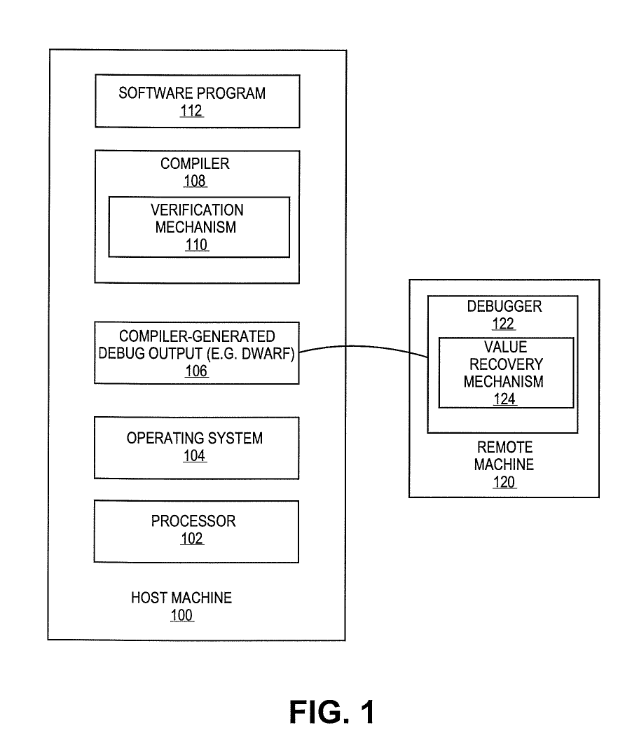

FIG. 1 illustrates a host machine 100 and a remote machine 120 employing a system for describing optimized away parameters according to one embodiment of the invention. In one embodiment, during compilation of a source code, certain verification information relating to optimized away parameters (also referred to as “arguments”) is gathered by a compiler 108 and then provided in a compiler-generated debug output 106. A debugger, in one embodiment, is capable of accessing the verification information relating to the parameter and, based on that information, locating values of the optimized away parameters and their corresponding variables.

Host machine 100 includes a base hardware platform having a processor 102 that is capable, for example, of working with a standard operating system 104. Operating system 104 serves as an interface between hardware/physical resources of the host machine 100 and the user. In some embodiments, base hardware platform may include memory devices, network devices, drivers, and so on.

Host machine 100 hosts a compiler 108 for compilation of source codes into machine codes, such as transforming the source code of software program 112 from a high-level programming language or source language (e.g., C, C++, etc.) to a lower level language or object code (e.g., machine code, assembly language, etc.) such that the software program 112 can become an executable program. Compiler 108 includes a software tool for transforming the software program 112 written with a high-level programming language into a low level machine code understandable by a computer system. Compilation includes generating the low level machine code and annotations which are then stored at a storage device as debug output 106. One example of such compiler-generated debug output 106 is the well-known Dwarf® debug output whose output format is referred to as Dwarf debug format that employs Debugging Information Entries (“DIE”). The Dwarf format is referenced in this document merely as an example for brevity, clarity and ease of understanding and it is contemplated that the embodiments of the invention are not limited to the Dwarf format or any other particular debug output format.

Code optimization is aimed at making the result of such transformation as efficient as possible by, for example, minimizing or maximizing various attributes of the executable program. Code optimization refers to a process of modifying the software program 112 so that it execute more rapidly while consuming less storage, power, and other resources.

In a typical source code, the initial storage or passing location (e.g., register or stack slot) that a parameter has to pass through is defined or known. However, once a register has hosted the parameter, the register may then be reused for other purposes (since the goal of code optimization is to promote efficiency) and consequently, the parameter is optimized away. The parameter may be saved somewhere and prevented from being optimized away if there remains a future use for it in the source code.

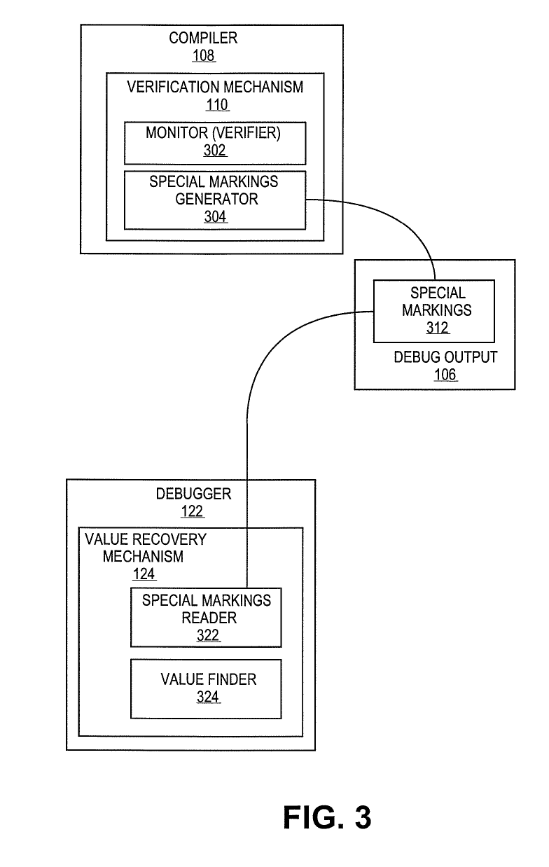

In one embodiment, verification mechanism 110 at the compiler 108 is used to monitor source code parameters to determine and verify the parameters' status, characteristics, and history, etc., and then provide relevant information in the debug output 106 to assist the debugger 122 in recovering values of optimized away parameters. The verification mechanism 110, in one embodiment, uses some of the information (e.g., references associated with parameters, user or other predefined conditions relating to parameters, etc.) made available by the compiler 108 to monitor each parameter. The results of this monitoring my provide information like whether a given parameter is subject to a predefined condition or has it been modified or remained unchanged, etc. In some cases, when a parameter is modified, the value that modified the parameter may be known or defined, such as a constant value that was added to or subtracted from, etc., the original value of the parameter. This verification information collected by the verification mechanism 110 may be provided in the debug output 106 as special markings (including notes, expressions, formulae, etc.) defining the optimized away parameters for the debugger 122 and for it to access and use these special markings to determine values of the optimized away parameters and variables. More particularly, the special markings include variable or parameter location description information and call site information as described with respect to FIG. 3.

In one embodiment, at a remote system 120, the value recovery mechanism 124 of the debugger 122 possesses the ability to access and analyze special markings and other relevant information of the debug output 106. As stated above, these special markings define the optimized away parameters by providing relevant information about these parameters, such as certain notes or expressions stating the historical status of a parameter, such as its location description information and call site information, to be used by the debugger 122 for perform a recovery process to recover the optimized away parameter values, information about known variables and/or constants associated with a parameter, etc. The debugger 122 accesses the debug output 106 and detects a variable or parameter location description information expression (e.g., “parameter A passed through register R between code instructions 17 and 21”, etc.) in the special markings and, in further investigating the expression, finds the relevant call site information (e.g., “parameter A had a value associated with it”, etc.) in these special markings. In one embodiment, the debugger 122 finds the relevant call site information and then unwinds to the caller and, if needed, the expression for the value passed to the parameter is evaluated in the context of the caller (which, when it is not a constant, may need unwinding to the caller). In one embodiment, the debugger 122 upon detecting the special markings in the variable or parameter location information (such as those that tell the debugger 122 that the variable or parameter has at that spot a value equal to the one that has passed in some parameter), looks up corresponding call site information and finds information relating to that parameter in it and, if needed, evaluates that in the context of the caller.

The debugger 122 refers to a debugging software application that accesses and uses the debug output 106 to perform debugging of the software program 112. Typically, the process of debugging is used for finding and reducing any errors, defects, and bugs in the software program 112 by loading and storing the debug output 106 (including machine code and annotations) produced during compilation and running the machine code to examine the annotations in concert with running the machine code. In the illustrated embodiment, the remote machine 120 employs the debugger 122 having the value recovery mechanism 124. In one embodiment, either one the two machines 100, 120 includes both the compiler having the verification mechanism 110 and the debugger 122 having the value recovery mechanism 124. It is also contemplated that the debug output 106 may be stored at any of the host machine 100, the remote machine 120, and another storage medium. Further, each of the two machines 100, 120 may include a server computer system or a client computer system.

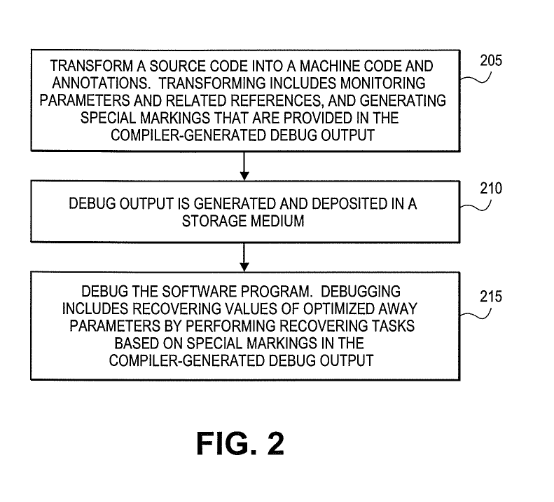

FIG. 2 illustrates a method for describing optimized away parameters according to one embodiment of the invention. Method 200 may be performed by processing logic that may comprise hardware (e.g., circuitry, dedicated logic, programmable logic, microcode, etc.), software (such as instructions run on a processing device), or a combination thereof, such as firmware or functional circuitry within hardware devices. In one embodiment, method 200 is performed by verification mechanism and value recovery mechanism of FIG. 1.

Method 200 begins at block 205 where a software program is transformed or compiled into a machine code and annotations by a compiler. This compilation further includes code optimization during which source code parameters are optimized away. In one embodiment, a verification mechanism gathers information about these parameters during compilation using some of the information and tools by the compiler and describes the parameters by providing special markings (including variable or parameter location description information, call site information, etc.) in the compiler-generated debug output.

At block 210, debug output is generated by the compiler and deposited in a storage medium. Subsequently, at block 215, debugging of the software program is performed by having a debugger access and use the stored debug output. In one embodiment, in response to a request by a user for the value of an optimized away parameter (and/or a related variable), the debugger, using the special markings, performs a recovery process to recover the value of the optimized away parameter (and/or calculate the value of the variable). In one embodiment, the debugger upon detecting the special markings in the variable or parameter location information (such as those that tell the debugger that the variable or parameter has at that spot value equal to that has passed in some parameter), looks up corresponding call site information and finds information relating to that parameter in it and, if needed, evaluates that in the context of the caller. Once the parameter value is located or recovered, the debugger provides the value to the user.

FIG. 3 illustrates a system 300 for describing optimized away parameters and locating their values according to one embodiment of the invention. In the illustrated embodiment, compiler 108 includes a verification mechanism 110 which further includes a monitor (verifier) 302 and a special markings generator 304. In one embodiment, special markings 312 includes variable or parameter location description information relating to a parameter and its relevant call site information. Variable or parameter location description information refers to information relation to a parameter or a variable passing between instructions and having the same value as the value of a parameter that passed in a location on a function entry, such as “parameter or variable X between instructions N1 and N2 has the same value as the parameter passed in location L had on function entry”, etc. Call site information refers to information relating to a call instruction that calls a function and passes a first value to a first parameter that passed in a first location and/or passes a second value from a register to a second parameter in a second location, such that “call instruction N3 calls function F and passes value 24 to a parameter that passed in location L1, and passes value 36 from register R to a parameter that passed in location L2”, etc. The variable or parameter location description information and call site information of the special markings 312 are further discussed below.

In one embodiment, the verification mechanism 110 determines, for example, whether a given parameter's value has remained unchanged or been modified throughout the source code instructions, and through which register, the parameter passed and when, such as during which instructions of the source code. To accomplish this task, in one embodiment, the monitor 302 reads and understands the source code and then follows the references associated with each parameter to find out whether any of the references indicates a modification being made to a parameter. In one embodiment, the monitor 302 works in concert with compiler-based parameter tracking entities and other compiler-provided relevant information (e.g., various references associated with variables and parameters) to monitor these parameters. One such tracking system is a value-based tracking system. For example, for each variable (and parameter), the compiler 108 tracks the register or memory location in a function track where a variable or parameter is stored as well as the VALUE (e.g., special artificial entity) associated with the variable or parameter. The compiler 108 further tracks the register or memory location for these special artificial VALUE entities and their equivalent VALUES (or expressions involving VALUEs). In one embodiment, for example, the VALUEs that a function parameter has at the first instruction of a function is then translated into a new special artificial location, such as “entry value of parameter passed in register X or stack slot Y”. Register/memory location is used, in one embodiment, such that if a variable's current value is located in a register or memory, it is then recorded in the debug output 106. If this the current value is no longer available in the register or memory, it may still have the VALUE some function parameter had at the first instruction (or some expression involving that) and the relevant special new markings 312 can then be added to the debug output 106.

Once the monitoring process is completed and/or sufficient information about a parameter is obtained, the monitor 302, using its verification module or verifier, verifies (or proves or guarantees) the status of that parameter, such as whether the parameter was modified or remained unchanged, was there a value (e.g., a constant) associated with the parameter (e.g., added, subtracted, multiplied, divided, etc.) at some point and is this value known (e.g., if the parameter was modified), are there any predefined conditions associated with the parameter (e.g., this parameter is not allowed to be modified), are there any variables or other parameters associated with this parameter (so their values can be calculated), and so forth.

In one embodiment, as aforementioned, variable or parameter location description information (e.g., “parameter or variable X between instruction N1 and N2 has the same value as parameter passed in location L had on function entry”, etc.) is provided in the special markings 312 of debug output 106. In one embodiment, while investigating the variable or parameter description information, the debugger 122 finds the relevant call site information (e.g., “call instruction N3 calls function F and passes value 24 to parameter passed in location L1, passes value from register R to parameter passed in location L2”, etc.) in the special markings 312 to further assist the debugger 122 with the recovery process. Call site information refers to information that relates to which function is called at which spot and what values were passed to each of the parameters at that (relevant) call site. Based on a combination of the variable or parameter location description information and the relevant call site information, special markings 312 are generated by the special markings generator 304 and provided in the debug output 106.

In one embodiment, the value recovery mechanism 124 includes a special markings reader 322 that is capable of accessing and reading the special markings 312 provided as part of at the debug output 106. Once these special markings 312 have been read by the special markings readers 322, a value finder 324 of the value recovery mechanism 124 initiates and performs an appropriate recovery process to recover the value of an optimized away parameter. The value is then provided to the user. In one embodiment, the debugger 122 finds the relevant call site information and then unwinds to the caller and, if needed, the expression for the value passed to the parameter is evaluated in the context of the caller (which, when it is not a constant, may need unwinding to the caller). In one embodiment, the debugger 122 upon detecting the special markings 312 in the variable or parameter location information (such as those that tell the debugger 122 that the variable or parameter has at that spot a value equal to the one that has passed in some parameter), looks up the corresponding call site information and finds information relating to that parameter in it and, if needed, evaluates that in the context of the caller.

As aforementioned, the special markings 312 includes variable or parameter location description information and call site information. When the debugger 122 accesses the debug output 106, the special markings reader 322 first detects or finds the variable or parameter location description information (e.g., “parameter A passed through register R between code instructions 17 and 21”, etc.) and then detects or finds the relevant call site information where it finds information like “parameter A had value 24 associated with it” or “parameter A had a value loaded from register S” (where register S is preserved across the call) or “parameter A had a value loaded from memory M” (where again, the memory slot is not clobbered by the call), or “parameter A had a value of some expression, involving constants, registers, and memory” (where those registers and memory are not clobbered by the call).

Along with the variable or parameter location description information, the unwind information is used by the debugger 122 in unwinding to the caller to have the necessary information regarding the caller function (e.g., variables listed in the caller, etc.) and complete the expression and remember the value to be provided to the user. For example, based on the variable or parameter location information and the relevant call site information, the value finder 324 unwinds to the caller in which the location of a register, such as register R, of the caller has been saved to determine the value that has passed to the function, because the process of unwinding allows the debugger 122 to reach the location (e.g., register R) from where the parameter (e.g., parameter A) passed and, continuing with the example, temporarily restore the value (e.g., a value of 6) of register R as it was during code instructions 17 and 21. This restored value (e.g., 6) is the original value of parameter A. The debugger 122 then displays, via a display device, the restored parameter A value to the user that requested it.

Regarding unwinding, the unwinding may not be needed when, for example, a constant is passed to a parameter because, in that case, the value is known immediately. Thus, the unwinding may be needed if, for example, some (call preserved) register is in the expression (e.g., disclosed by the variable or parameter location description information of the special markings 312) because, in that case, the debugger 122 cannot use the value of that register from the current function and rather, uses the value of that register from a caller's context. Further, the process of unwinding happens later in the process and includes, for example, the following: (1) a user queries a value of a variable (or parameter) X; (2) the debugger 122 finds the location description information for X; (3) in the location description information, the debugger 122 finds a location description relevant for the current instruction; (4) if that location is specified in the special markings 312 (e.g., “entry value of parameter passed in location L”, etc.); (5) then, the debugger 122 finds call site information for the caller of the current function; (6) verifies the call site information if that information is relevant to the current function (e.g., no tail calls are involved); (7) in the call site information, the debugger 122 finds information about the parameter passed in location L; (8) unwinds to the caller, and computes the value passed to that parameter by evaluating the expression in the context of the caller function; and (9) and returns the computed value which is then provided to the user.

In those cases where the value of a parameter is changed with a known value (e.g., a known constant value of 10 is added to the parameter), and the parameter was not used in the source code after that modification, then the special markings 312 in the debug output 106 may provide an expression regarding the constant, such as “a constant has been passed to parameter A” or “parameter A passing through register R between code instructions 17 and 21 plus 10” or the like. Using the above example, in this case, the value finder 324, based on the special markings 312, unwinds to the caller to locate the value (e.g., 6) that had passed parameter A and then goes back and adds 10 to the parameter value to provide and display a final value of 16 (e.g., parameter A value 6+constant value 10). It is contemplated that the value is not only added to a parameter value, but that it may be subtracted, multiplied, divided, or the like.

In one embodiment, in case a parameter is loaded with a value from a “call preserved register” or “call preserved memory”, then that value from the call preserved register is considered the value of the parameter. This is because an original value in a call preserved register is maintained, i.e., even if a call preserved register is changed and used for other purposes, its original value is restored in accordance with the Application Binary Interface (“ABI”) standard. Similarly, any parameter value at a memory slot is considered the parameter's unchanged value, since, unlike a processor register, a memory slot is not changed to be used for other purposes. Further, if the value of a parameter is known, a special marking expression may reveal that by stating “a value of 6 has passed this parameter”, etc.

With regard to variables, their values may depend on their relationship with one or more parameters and their changing values. For example, in some cases, when a relationship between a parameter and a variable is defined at the beginning of a function, such as variable X (value)=parameter A (original value), then even if the value of parameter A is later modified, the value of variable X remains the same, i.e., the original value of parameter A. In this case, as aforementioned, the value finder 324 locates the original value of parameter A and consequently, the value of variable X (because, as above, variable X (value)=parameter A (original value)). Similarly, if variable Q (value)=parameter A (original value)+parameter B (original value), the special markings 312 may provide some information, such as “parameter A passed through register R during code instructions 17 thru 21 and parameter B passed through register T during instructions 42 thru 47”. Using the unwinding technique, the value finder 324 locates the original values of parameters A and B and, once these original parameter A and B values are known, the value of variable Q is calculated by adding the restored original values of parameters A and B. It is contemplated that both parameters A and B may pass through the same register (e.g., register R) at different times in the code.

One difference between variables and parameters is that the variables are initialized in a function, while the parameters are initialized during a call of a function; however, once called and initialized, a parameter works just like any variable in the function. For example, using a programming language, a function (e.g., fn1) is called with multiple parameters (e.g., fn1 (long int a, long int b)) and further down the code, a variable is defined as long int q=2*a. This means the value of variable q is 2 times the value of parameter a.

Depending on the type of compiler 106 and/or the programming language, the verification mechanism 108 may perform its tasks, such as monitoring the parameters, at any given time during the compilation process. For example, at any point during compilation, if a parameter's address is passed on from one function to another and what happened to the parameter at the other function cannot be verified, then the parameter is assumed to have been modified; while, if a parameter never escapes a function and is designed to work in a particular manner (e.g., on the right side of all expressions), the parameter is quickly verified to have remained unchanged. In some cases, depending on the programming language, a user may choose to predefine a parameter, such as by restricting its value from being modified and, in such cases, the parameter is verified to have remained unchanged. Although the exact expressions or notes in the special markings 312 may vary or be absent, but the special markings 312 of the compiler 108 does provide sufficient parameter-related information (e.g., instruction ranges, register names, any constant values, etc.) in the debug output 106 that the debugger 122 can use that information to restore parameter values.

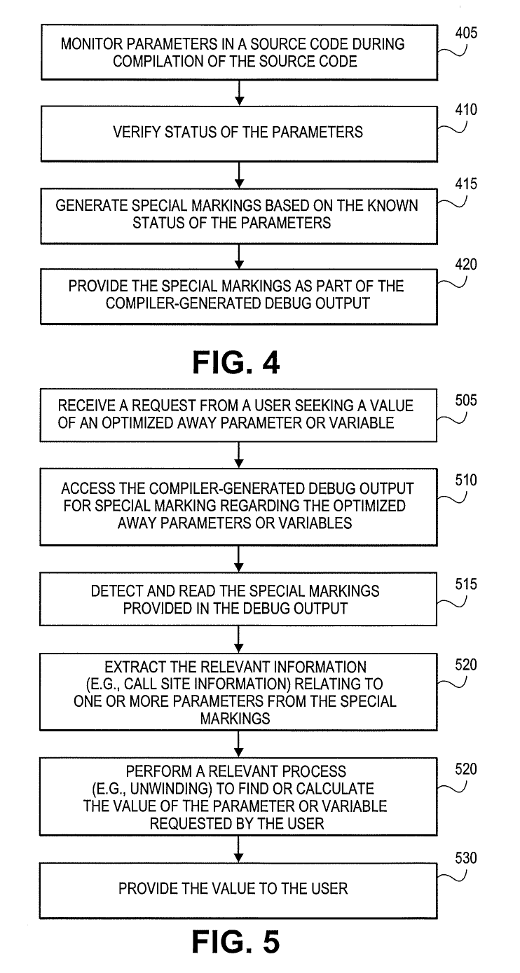

FIG. 4 illustrates a method for describing values of optimized away parameters according to one embodiment of the invention. Method 400 may be performed by processing logic that may comprise hardware (e.g., circuitry, dedicated logic, programmable logic, microcode, etc.), software (such as instructions run on a processing device), or a combination thereof, such as firmware or functional circuitry within hardware devices. In one embodiment, method 400 is performed by verification mechanism of FIG. 1.

Method 400 begins by monitoring parameters in a source code during compilation of the source code at block 405. In one embodiment, the parameter monitoring is performed using various compiler-based tracking entities and references, etc. At block 410, the status of each parameter is verified, such as whether a parameter is modified or remained unchanged, which register the parameter passed through, etc. Based on the known status of the parameters, special markings are generated at block 415. These special markings serve as instructions for a debugger so that it may perform a recovery process to recover the values of optimized away parameters. At block 420, special markings are provided as part of the compiler-generated debug output (as the parameters are optimized away during code optimization). As aforementioned, the special markings includes variable or parameter location description information and the relevant call site information to help the debugger with its recovery process.

FIG. 5 illustrates a method for describing values of optimized away parameters according to one embodiment of the invention. Method 500 may be performed by processing logic that may comprise hardware (e.g., circuitry, dedicated logic, programmable logic, microcode, etc.), software (such as instructions run on a processing device), or a combination thereof, such as firmware or functional circuitry within hardware devices. In one embodiment, method 400 is performed by value recovery mechanism of FIG. 1.

Method 500 begins with receiving a request from a user seeking a value of an optimized away parameter or a related variable at block 505. In response to the request, a debugger accesses the compiler-generated debug output to access special markings regarding optimized away parameters at block 510. At block 515, the debugger's special markings reader accesses, reads, and analyzes the special markings provided in the debug output. At block 520, the debugger extracts the relevant information relating to the optimized away parameters from the special markings at the debug output. At block 525, based on this special markings information, the debugger, via its value finder, performs a recovery process to locate values of the optimized away parameters and, if requested and/or needed, calculate values of the corresponding variables. These recovered and/or calculated values are provided to the user by having them displayed on a display device at block 530. As aforementioned, the debugger when accessing special markings finds variable or parameter location description information and upon further investigation of the variable or parameter location description information, finds the relevant call site information. In one embodiment, the debugger unwinds to the caller to find the relevant call site information and evaluates the corresponding value expression passed to the parameter in the context of the caller (which, when it is not a constant, may need unwinding to the caller). In one embodiment, the debugger upon detecting the special markings in the variable or parameter location information (such as those that tell the debugger that the variable or parameter has at that spot a value equal to the one that has passed in some parameter), looks up corresponding call site information and finds information relating to that parameter in it and, if needed, evaluates that in the context of the caller. Upon find the value, the debugger sends the value to be displayed to the user on a display device.

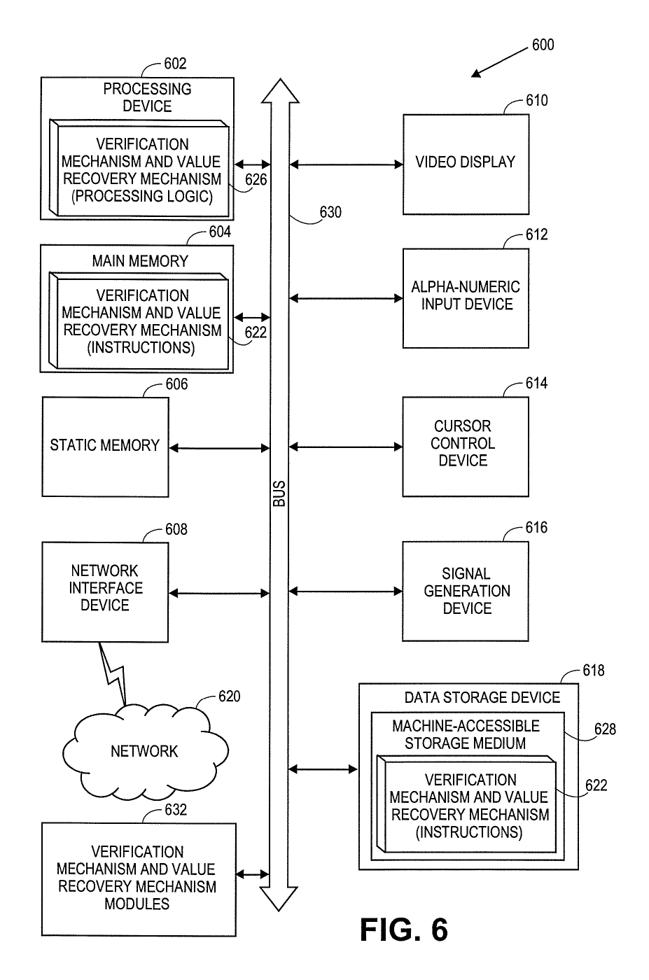

FIG. 6 illustrates a computer system 600 for employing verification mechanism and value recovery mechanism according to one embodiment of the invention. Within the computer system 600 is a set of instructions for causing the machine to perform any one or more of the methodologies discussed herein. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing device 602, a main memory 604 (e.g., read-only memory (ROM), flash memory, random access memory (RAM), dynamic RAM (DRAM) such as synchronous DRAM (SDRAM), DRAM (RDRAM), etc.), a static memory 606 (e.g., flash memory, static random access memory (SRAM), etc.), and a secondary memory 618 (e.g., a data storage device in the form of a drive unit, which may include fixed or removable machine-accessible or computer-readable storage medium), which communicate with each other via a bus 630.

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute the processing logic 626 for performing the operations and methods discussed herein.

The computer system 600 may further include a network interface device 608. The computer system 600 also may include a video display unit 610 (e.g., a liquid crystal display (LCD) or a cathode ray tube (CRT)) connected to the computer system through a graphics port and graphics chipset, an alphanumeric input device 612 (e.g., a keyboard), a cursor control device 614 (e.g., a mouse), and a signal generation device 616 (e.g., a speaker).

The data storage device 618 may include a machine-accessible storage medium (or a computer-readable storage medium) 628 on which is stored one or more sets of instructions 622 (e.g., verification mechanism and value recovery mechanism) embodying any one or more of the methodologies or functions described herein. The verification mechanism and value recovery mechanism may also reside, completely or at least partially, within the main memory 604 (e.g., verification mechanism and value recovery mechanism (instructions) 622) and/or within the processing device 602 (e.g., verification mechanism and value recovery mechanism (processing logic) 626) during execution thereof by the computer system 600, the main memory 604 and the processing device 602 also constituting machine-readable storage media. Further, for example, the verification mechanism and value recovery mechanism instructions 622 may be transmitted or received over a network 620 via the network interface device 608. As aforementioned with reference to FIG. 1, in one embodiment, verification mechanism and value recovery mechanism may be employed on the same computer system or on different computer systems, such as pointer replacement mechanism resides on one computer system while each of several other computer systems having an implicit pointer dereferencer.

The machine-readable storage medium 628 may also be used to store the verification mechanism and value recovery mechanism (instructions) 622 persistently. While the machine-accessible storage medium 628 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present invention. The term “machine-accessible storage medium” shall accordingly be taken to include, but not be limited to, solid-state memories, and optical and magnetic media.

Verification mechanism and value recovery mechanism modules 632, components and other features described herein (for example in relation to FIG. 1) can be implemented as discrete hardware components or integrated in the functionality of hardware components such as ASICS, FPGAs, DSPs or similar devices. In addition, the modules 632 can be implemented as firmware or functional circuitry within hardware devices. Further, the modules 632 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “monitoring”, “calculating”, “verifying”, “dumping”, “finding”, “locating”, “recovering”, “generating”, “allocating”, “establishing”, “translating”, “transforming”, “optimizing”, “debugging”, “determining”, “detecting”, “receiving”, “providing”, displaying”, “linking”, “extracting”, “accessing”, performing”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a machine readable storage medium, such as, but not limited to, any type of disk including floppy disks, optical disks, magnetic-optical disks, ROMs, compact disk ROMs (CD-ROMs), RAMs, erasable programmable ROMs (EPROMs), electrically EPROMs (EEPROMs), magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., ROM, RAM, magnetic disk storage media, optical storage media, flash memory devices, etc.), a machine (e.g., computer) readable transmission medium (non-propagating electrical, optical, or acoustical signals), etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. A computer-implemented method comprising:
monitoring parameters in a source code during compilation of the source code by a compiler on a computer system, wherein each parameter includes a value and is optimized away during optimization of the source code into an optimized code;
generating status information relating to the parameters based on the monitoring of the parameters; and
providing the status information in a debug output generated by the compiler, wherein the status information is used to recover values of the parameters missing from the optimized code.

2. The computer-implemented method of claim 1, wherein monitoring comprises tracking the parameters in the source code, and studying references corresponding to the parameters.

3. The computer-implemented method of claim 1, wherein the status information comprises variable or parameter location description information, wherein the variable or parameter location description information includes information relation to a parameter or a variable within an instruction range having a same value as a parameter that passed in a particular location on a function entry.

4. The computer-implemented method of claim 3, wherein the status information further comprises call site information relating to each call instruction, wherein the call site information includes information relating to a call instruction that calls a function and describes values passed to one or more parameters.

5. The computer-implemented method of claim 1, further comprising, at a debugger, in response to a request from a user requesting a value of an optimized away parameter, accessing the status information at the debug output.

6. The computer-implemented method of claim 5, further comprising, at the debugger, upon detecting special markings in variable or parameter location information of the status information, looking up corresponding call site information and finding information relating to the optimized away parameter in it and, if necessitated, evaluating the information in context of a caller.

7. The computer-implemented method of claim 5, further comprising providing the value of the optimized away parameter to the user by displaying the value on a display device.

8. A system comprising:
a processor communicably coupled to a memory on a host computer system; and
a compiler communicably coupled to the processor, the compiler having a verification mechanism operable to:
monitor parameters in a source code during compilation of the source code by the compiler, wherein each parameter includes a value and is optimized away during optimization of the source code into an optimized code;
generate status information relating to the parameters based on the monitoring of the parameters; and
provide the status information in a debug output generated by the compiler, wherein the status information is used to recover values of the parameters missing from the optimized code.

9. The system of claim 8, wherein monitoring comprises tracking the parameters in the source code, and studying references corresponding to the parameters.

10. The system of claim 8, wherein the status information comprises variable or parameter location description information, wherein the variable or parameter location description information includes information relation to a parameter or a variable within an instruction range having a same value as a parameter that passed in a particular location on a function entry.

11. The system of claim 10, wherein the status information further comprises call site information relating to each call instruction, wherein the call site information includes information relating to a call instruction that calls a function and describes values passed to one or more parameters.

12. The system of claim 10, further comprising a debugger on the host computer system or on a remote computer system coupled with the host computer system, the debugger having a value recovery mechanism to in response to a request from a user requesting a value of an optimized away parameter, access the status information at the debug output.

13. The system of claim 12, wherein the value recovery mechanism is further to upon detecting special markings in variable or parameter location information of the status information, look up corresponding call site information and finding information relating to the optimized away parameter in it and, if necessitated, evaluate the information in context of a caller.

14. The system of claim 12, further comprising a display device coupled to the host computer system, the display device to display the value of the optimized away parameter.

15. An article of manufacture comprising a machine-readable storage medium including data that, when accessed by a machine, cause the machine to perform operations comprising:
monitor parameters in a source code during compilation of the source code by a compiler on a computer system, wherein each parameter includes a value and is optimized away during optimization of the source code into an optimized code;
generate status information relating to the parameters based on the monitoring of the parameters; and
provide the status information in a debug output generated by the compiler, wherein the status information is used to recover values of the parameters missing from the optimized code.

16. The article of manufacture of claim 15, wherein the status information comprises variable or parameter location description information, wherein the variable or parameter location description information includes information relation to a parameter or a variable within an instruction range having a same value as a parameter that passed in a particular location on a function entry.

17. The article of manufacture of claim 15, wherein the status information further comprises call site information relating to each call instruction, wherein the call site information includes information relating to a call instruction that calls a function and describes values passed to one or more parameters.

18. The article of manufacture of claim 17, further comprising, at a debugger, in response to a request from a user requesting a value of an optimized away parameter, accessing the status information at the debug output.

19. The article of manufacture of claim 18, further comprising, at the debugger, upon detecting special markings in variable or parameter location information of the status information, looking up corresponding call site information and finding information relating to the optimized away parameter in it and, if necessitated, evaluating the information in context of a caller.

20. The article of manufacture of claim 18, wherein the data when accessed by the machine, further cause the machine to perform operations comprising: providing the value of the optimized away parameter to the user by displaying the value on a display device.
